(19) United States
(12) Patent Application Publication
(10) Pub. No.: US 2026/0109249 A1
(43) Pub. Date: Apr. 23, 2026

(54) CHARGING APPARATUS FOR ELECTRIC VEHICLE

(71) Applicants: HYUNDAI MOTOR COMPANY, SEOUL (KR); KIA CORPORATION, SEOUL (KR)

(72) Inventors: Ho Choi, Hwaseong-si (KR); Seung Tack Hong, Hwaseong-si (KR); Woo Hyung Lee, Hwaseong-si (KR); Sin Kuk Kim, Hwaseong-si (KR); Su Hwan Cho, Hwaseong-si (KR)

(73) Assignees: HYUNDAI MOTOR COMPANY, SEOUL (KR); KIA CORPORATION, SEOUL (KR)

(21) Appl. No.: 19/256,957

(22) Filed: Jul. 1, 2025

(30) Foreign Application Priority Data
Oct. 18, 2024 (KR) 10-2024-0142969
Nov. 12, 2024 (KR) 10-2024-0159976

(51) Int. Cl. B60L 53/31; B60L 53/18

(52) U.S. Cl. CPC B60L 53/31; B60L 53/18

(57) ABSTRACT

A charging apparatus for an electric vehicle includes an outer case having a charging cable, a first arm rotatably connected to the outer case, a second arm rotatably connected to the first arm and supporting a portion of the charging cable, and a pivot module mounted on the outer case and connected to the first arm via a connecting rod, the pivot module allowing the first arm to return toward the outer case when an external force is released.

### CROSS REFERENCE TO RELATED APPLICATIONS

This application claims benefit of priority to Korean Patent Application No. 10-2024-0142969 filed on Oct. 18, 2024 and Korean Patent Application No. 10-2024-0159976 filed on Nov. 12, 2024 in the Korean Intellectual Property Office, the disclosures of which are incorporated herein by reference in their entirety.

### TECHNICAL FIELD

The present disclosure relates to a charging apparatus for an electric vehicle that prevents contamination of or damage to a charging cable by preventing a charging cable from coming into contact with the ground, and is convenient to use.

### BACKGROUND

Electric vehicles such as electric passenger cars, electric trucks, and electric buses obtain power from batteries and drive motors to move. Such batteries should be charged periodically, and users may charge the batteries using public charging devices installed on roads, or the like, or using commercial power supplies domestically.

The charging devices have a charging cable with a charging gun connected to an end of the charging cable, and the charging gun has a built-in connector for a plug. As the charging power increases, a thick and heavy high-capacity cable is applied to the charging cable, and should have sufficient length to be connected to multiple vehicles having different charging plug locations due to location conditions of the charging device.

As the weight and length of the charging cable increase as described above, the charging cable moves while in contact with the ground during charging, and as a result, the outer covering of the charging cable may be frequently damaged. This may cause an inconvenience for users because they should be very careful when handling the charging cable connected to the charging gun, and the charging device may cause accidents due to leakage current or the like caused by damage to the charging cable.

### SUMMARY

An aspect of the present disclosure is to provide a charging apparatus for an electric vehicle that prevents contamination of or damage to a charging cable by preventing a charging cable from coming into contact with the ground and is convenient to use.

According to an aspect of the present disclosure, a charging apparatus includes an outer case having a charging cable, a first arm rotatably connected to the outer case, a second arm rotatably connected to the first arm and supporting a portion of the charging cable, and a pivot module mounted on the outer case and connected to the first arm via a connecting rod, the pivot module allowing the first arm to return toward the outer case when external force is released.

The first arm may be rotated and unfolded from the outer case in a first direction, and the second arm may be rotated and unfolded from an end of the first arm in a second direction, and the first direction and the second direction may be opposite directions.

One end of the first arm may be connected to the outer case via a first hinge, one end of the second arm may be connected to the other end of the first arm via a second hinge, and the second hinge may include a spring hinge.

The other end of the first arm may have a first connecting portion, and one end of the second arm may have a second connecting portion. The first connecting portion may include a first receiving portion inside thereof, and the second connecting portion may include a second receiving portion and a third receiving portion spaced apart from each other. The second receiving portion may have a first plug coupled thereto, and the third receiving portion may have a second plug coupled thereto.

The spring hinge may include a sleeve inserted into the first receiving portion and fixedly coupled to the first receiving portion, a spring seat fixedly coupled to an inner surface of the sleeve, a guide shaft disposed to extend in a longitudinal direction of the sleeve within the sleeve, and having one end on which a head formed with a plurality of first latches is provided and the other end inserted into the spring seat, a catch fixing portion fixedly coupled to an inner surface of the second receiving portion, and having a plurality of second latches formed thereon and engaged with the first latch, a torsion spring disposed to surround the guide shaft within the sleeve, and having a first end fixed to the spring seat and a second end fixed to the head, and an adjusting screw penetrating the second plug and screw-connected to the other end of the guide shaft.

The sleeve, the spring seat, the first receiving portion, and the first connecting portion may rotate together, and the guide shaft, the catch fixing portion, the second receiving portion, the third receiving portion, the second plug, and the second connecting portion may rotate together. The spring hinge may be configured to enable the second arm to rotate to be folded toward the first arm by restoration force of the torsion spring.

The pivot module may include a cylinder mounted in the outer case, having an internal space, and having operating fluid contained in the internal space, a piston inserted into the internal space and capable of reciprocating, and dividing the internal space into a first chamber and a second chamber, a rack formed on one side of an outer circumference surface of the piston, a pinion disposed on an outside of the internal space, having a shaft fixed thereto, and engaged with the rack, a coil spring elastically supporting the piston in the internal space, and an operating fluid path provided on one side wall of the cylinder and communicating with the first chamber and the second chamber. The connecting rod may connect the shaft and the first arm.

The piston may include a check valve, and the check valve may include a through hole formed in the piston, and a ball member disposed in the through hole to open and close the through hole.

One end of the connecting rod may fixedly be coupled to the shaft, and the connecting rod may rotate together with the shaft. The other end of the connecting rod may be rotatably connected to the first arm. The pivot module may be configured to rotate the first arm to be folded toward the outer case by restoration force of the coil spring.

The connecting rod may include a first rod member and a second rod member, and a length of the connecting rod may be variable.

One end of the first rod member may be fixedly coupled to the shaft, and the other end of the first rod member may be provided with at least one protrusion formed thereon. One end of the second rod member may be rotatably connected to the first arm, and the second rod member may be provided with a slot extending along a longitudinal direction of the second rod member. The protrusion may be inserted into the slot and may be movable within the slot.

The first arm may include a rail mounted on one side to extend along a longitudinal direction of the first arm, and a slider installed on the rail and movable along the rail, and an end of the connecting rod may be rotatably connected to the slider.

The pivot module may be installed to be recessed from a surface of the outer case and to be covered by the first arm and the second arm when the first arm and the second arm are folded.

An outlet through which the charging cable is pulled out may be disposed on an upper portion of the outer case, and the first arm, the second arm and the pivot module may be disposed on an upper portion of the outer case.

The charging cable, the first arm, the second arm, and the pivot module may be respectively disposed on both sides of the outer case.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 is a perspective view from behind of a charging apparatus according to an embodiment;

FIG. 2 is a partial perspective view illustrating one-side arms of a charging apparatus according to an embodiment in an unfolded state;

FIG. 3 is a cross-sectional view illustrating a spring hinge of a charging apparatus according to an embodiment;

FIG. 4 is a cross-sectional view illustrating a pivot module of a charging apparatus according to an embodiment; and

FIG. 5 is a plan view illustrating a state of use of a charging apparatus according to an embodiment.

### DETAILED DESCRIPTION

In this specification, a vehicle refers to various vehicles that move a transported object such as a person, an animal, or an object from a starting point to a destination. Such vehicles are not limited to vehicles that run on roads or tracks.

In addition, terms such as first, second, and third may be used to describe various components, but these components are not limited in terms of order, size, location, or importance by terms such as first, second, and third, and are named only for the purpose of distinguishing one component from another.

Hereinafter, the present disclosure will be described in detail through illustrative drawings. When adding reference numerals to components in respective drawings, it should be noted that the same components are given the same numerals as much as possible even if they are illustrated in different drawings.

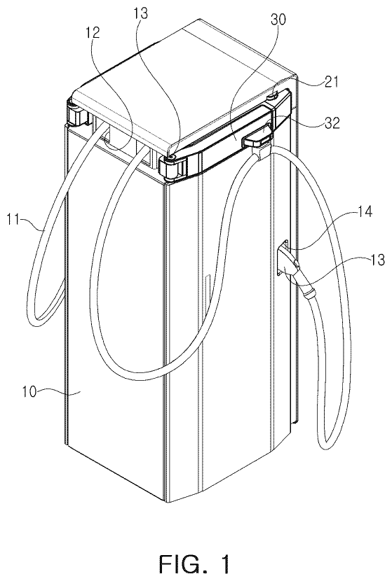

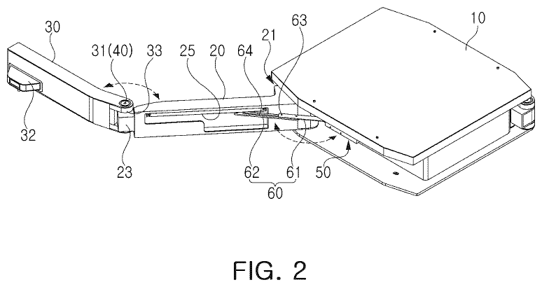

FIG. 1 is a perspective view from behind of a charging apparatus according to an embodiment, and FIG. 2 is a partial perspective view illustrating one-side arms of a charging apparatus according to an embodiment in an unfolded state.

A charging apparatus according to an embodiment may include an outer case 10, a first arm 20, a second arm 30, and a pivot module 50.

The outer case 10 is a member that constitutes the exterior of the charging apparatus, may have a shape of approximately a hexahedron, and may be made of a solid material such as metal or plastic. However, the shape and material of the outer case are not limited to the examples described above.

The outer case 10 may accommodate a charging body (not illustrated) inside thereof. The charging body may include a converter, a circuit breaker, a switch, a sensor, a controller, and the like.

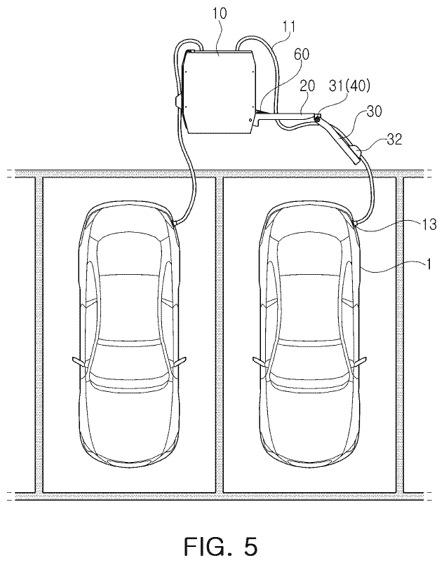

The charging body may be connected to an external power grid and may provide power input from the power grid to an electric vehicle 1 (see FIG. 5). The external power grid may adopt various power supply sources such as AC power of a three-phase system or DC power by an arbitrary generator.

The charging body may be equipped with a converter to convert power supplied from the power grid. For example, a DC/DC converter for controlling the level of DC power, or an AC/DC converter for rectifying and converting AC power of a three-phase system into DC power, may be provided. As a result, the charging body may charge the battery of the electric vehicle 1 using the converted DC power.

In addition, the charging body may be provided with a circuit breaker for reasons such as safety issues, and may include a switch for controlling whether or not to supply power, and a sensor for detecting whether or not the electric vehicle is connected, measuring the amount of charge, and monitoring overload, or the like.

The charging body may include a controller for controlling the overall operation of the charging apparatus. The controller may be electrically connected to the converter, circuit breaker, switch, sensor, or the like and may control converting power supplied from the power grid into a form that may charge the electric vehicle 1 and supplying the converted power to the electric vehicle.

The outer case 10 may be provided with a user interface (not illustrated) on one-side outer surface thereof. The user interface is electrically connected to the controller, and may receive commands from the user and display the charging results to the user while interacting with the user during the charging process, such as initiation of charging, payment of the fee, and charging.

Since this charging body and the user interface are already known technologies, a more detailed description of the configuration and operational relationship thereof will be omitted in this specification.

Inside the outer case 10, one end of the charging cable 11 is fixedly disposed, and one end of the charging cable may be electrically connected to the charging body. This charging cable may extend from the inside to the outside of the outer case by penetrating the outer case.

To this end, an outlet 12 through which the charging cable 11 can be withdrawn may be provided on the upper portion of the outer case 10. It may be preferable that the outlet is disposed on the upper portion of the outer case, but the present disclosure is not necessarily limited thereto.

In this case, the upper portion may mean a part corresponding to the upper half of the height of the outer case.

If the outlet 12 is disposed in the upper portion of the outer case 10, the charging cable 11 is configured to be withdrawn from the upper portion of the outer case, so that the charging cable may be prevented from contacting the ground, which in turn prevents any initial damage to the charging cable.

The charging cable 11 that is pulled out from the outer case 10 through the outlet 12 extends downward due to its own weight.

The charging cable 11 is provided with a charging gun 13 at the other end, and the charging gun may have a built-in connector for a plug that may be connected to a charging plug (not illustrated) of the electric vehicle 1. The charging gun may be stored in a holder 14 provided on one outer surface of the outer case 10, for example, one outer surface provided with a user interface.

Therefore, the charging apparatus according to an embodiment of the present disclosure is electrically connected to a battery of an electric vehicle 1 via the charging cable 11, and may provide power supplied and converted from the power grid to the battery and charge the battery.

The first arm 20 is rotatably installed on the upper portion of the outer case 10 and may be unfolded from the outer case or folded toward the outer case. To this end, one end of the first arm may be connected to the outer case via a first hinge 21. The first arm may be extended to a predetermined length, to protrude from the outer case to one side of the outer case.

The second arm 30 is rotatably installed at the other end of the first arm 20 and may be unfolded from the first arm or folded toward the first arm. To this end, one end of the second arm may be connected to the other end of the first arm via a second hinge 31. The second arm may be extended to a predetermined length, to protrude from the other end of the first arm.

In this case, the first arm 20 may be unfolded by rotating in a first direction (for example, clockwise) from the outer case 10, while the second arm 30 may be unfolded by rotating in a second direction (for example, counterclockwise) from the other end of the first arm.

For example, the unfolding directions of the first arm 20 and the second arm 30 may be opposite to each other. Similarly, the folding directions of the first arm and the second arm may be opposite to each other.

A connecting ring 32 for connecting a charging cable 11 may be installed at the other end of the second arm 30. The connecting ring may be installed to be rotatable relative to the second arm, but is not necessarily limited thereto.

In some embodiments, the second hinge 31 interposed between the first arm 20 and the second arm 30 may include a spring hinge 40.

In detail, the other end of the first arm 20 may be provided with a first connecting portion 23, and one end of the second arm 30 may be provided with a second connecting portion 33. The spring hinge 40 may be interposed between the connecting portions so that the first connecting portion 23 and the second connecting portion 33 may be rotatable relative to each other, thereby forming the second hinge 31.

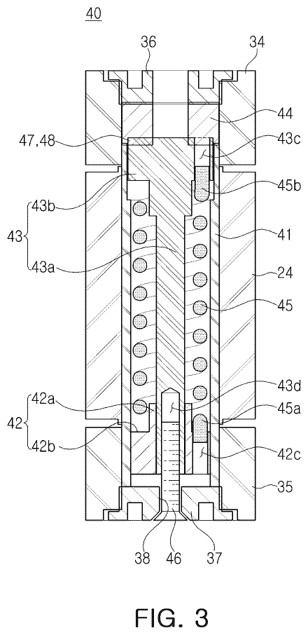

FIG. 3 is a cross-sectional view illustrating a spring hinge of a charging apparatus according to an embodiment.

In order for the spring hinge 40 to be applied, the first connecting portion 23 may include a first receiving portion 24 therein, and the second connecting portion 33 may include a second receiving portion 34 and a third receiving portion 35 formed spaced apart from each other.

The second receiving portion 34 and the third receiving portion 35 of the second connecting portion 33 may be respectively positioned on both ends of the first receiving portion 24 of the first connecting portion 23. As a result, the first connecting portion and the second connecting portion may form a second hinge 31 that may rotate around the axis of the aligned second receiving portion-first receiving portion-third receiving portion.

A first plug 36 may be coupled to the second receiving portion 34, and a second plug 37 may be coupled to the third receiving portion 35. The first plug may be screw-coupled to the second receiving portion, and the second plug may be screw-coupled to the third receiving portion.

In addition, a screw hole 38 to which an adjusting screw 46 described later may be fastened may be formed by penetrating through the second plug 37.

The spring hinge 40 constituting the second hinge may include, for example, a sleeve 41, a spring seat 42, a guide shaft 43, a catch fixing portion 44, a torsion spring 45, and an adjusting screw 46.

The sleeve 41 may be inserted and positioned inside the first receiving portion 24, the second receiving portion 34, and the third receiving portion 35, and may serve as a rotation axis of the first connecting portion 23 and the second connecting portion 33. The sleeve may be formed in a tubular shape with an approximately circular cross section.

The sleeve 41 may be fixed to, for example, the first receiving portion 24 and may rotate integrally with the first receiving portion and the first connecting portion 23. The sleeve may be fixedly coupled to the first receiving portion by a tightening screw (not illustrated) or the like, but is not necessarily limited thereto. For example, the sleeve may be formed integrally with the first receiving portion or may be coupled by press-fitting, joining, or the like.

Alternatively, a protrusion and a groove may be interposed between the sleeve 41 and the first receiving portion 24 so that the sleeve may be coupled at least so as not to rotate relative to the first receiving portion.

One end of the sleeve 41 is inserted into the second receiving portion 34 and may rotate relative to the second receiving portion. In addition, the other end of the sleeve is inserted into the third receiving portion 35 and may rotate relative to the third receiving portion.

The spring seat 42 is formed in a tubular shape with a T-shaped cross section and may include an insertion portion 42a for a guide shaft 43 and a mounting portion 42b for a torsion spring 45. The mounting portion may have an outer diameter that is further extended than an outer diameter of the insertion portion, for example, an outer diameter larger than an outer diameter of the insertion portion.

The spring seat 42 may have a first fixing groove 42c formed parallel to the axial direction of the insertion portion 42a. The first fixing groove may be formed at a position off the center of one side from which the insertion portion extends and protrudes from the mounting portion 42b.

The spring seat 42 may be fixedly coupled to the inner surface of the sleeve 41, for example, and may rotate integrally with the sleeve. The spring seat may be fixedly coupled to the sleeve by a joint such as welding, but is not necessarily limited thereto, and may be formed integrally with the sleeve, for example.

In this manner, the spring seat 42 and the sleeve 41, and the first receiving portion 24 and the first connecting portion 23, may rotate together as one unit.

The guide shaft 43 may be disposed to extend along the longitudinal direction of the sleeve 41 from the inside of the sleeve. The guide shaft may include a stem 43a and a head 43b positioned at one end of the stem. The head may have an outer diameter that is further extended than the outer diameter of the stem, for example, a larger outer diameter than that of the stem.

The head 43b may have a second fixing groove 43c formed parallel to the axial direction of the stem 43a. The second fixing groove may be formed at an off-center location on one side of the head adjacent to the stem.

In addition, the head 43b may include a plurality of first latches 47 formed to protrude from the other side on the opposite side of the stem, for example, far from the stem 43a. The plurality of first latches may be disposed in an annular shape on the other side of the stem.

An adjusting groove 43d formed in the axial direction of the guide shaft 43 and having a female screw thread may be formed in the other end of the stem 43a. The other end of this stem is inserted into the insertion portion 42a from one side of the spring seat 42 and the adjusting groove 43d is exposed on the other side, so that the adjusting screw 46 penetrating the screw hole 38 of the second plug 37 may be screwed into the adjusting groove.

The stem 43a is relatively rotatable with respect to the spring seat while being inserted into the insertion portion 42a of the spring seat 42.

The catch fixing portion 44 may be formed as a ring-shaped member and may include a plurality of second latches 48 formed to protrude from one side. The plurality of second latches may be disposed in a ring shape along the shape of the catch fixing portion.

The second latch 48 of the catch fixing portion 44 is positioned toward the head 43b of the guide shaft 43 and may engage with one of the plurality of first latches 47 on the head.

The catch fixing portion 44 may be fixedly coupled to the inner surface of the second receiving portion 34, for example, and may rotate integrally with the second receiving portion. The catch fixing portion may be fixedly coupled to the second receiving portion by means of a joint such as welding or the like, but is not necessarily limited thereto, and may be formed integrally with the second receiving portion, for example.

Thereby, the catch fixing portion 44, the second receiving portion 34, the third receiving portion 35 and the second connecting portion 33 may rotate integrally together with the guide shaft 43 via the second plug 37 and the adjusting screw 46.

Moreover, since the second latch 48 of the catch fixing portion 44 is engaged with the first latch 47 on the head 43b of the guide shaft 43 and is caught and fixed, when the catch fixing portion is rotated by the force applied to the second receiving portion 34, the guide shaft may be rotated together by receiving the force from the catch fixing portion.

The torsion spring 45 may be disposed to wrap around the guide shaft 43 and extend along the length of the guide shaft inside the sleeve 41. A first end 45a of the torsion spring may be inserted into and fixed in a first fixing groove 42c formed in the mounting portion 42b of the spring seat 42, and a second end 45b of the torsion spring may be inserted into and fixed in a second fixing groove 43c formed in the head 43b of the guide shaft 43.

The adjusting screw 46 may be screwed into the adjusting groove 43d formed in the stem 43a of the guide shaft 43 after being fastened to and penetrating through the screw hole 38 of the second plug 37 as described above. By this adjusting screw, the guide shaft 43 is fixed to the second plug, and may thus rotate integrally with the third receiving portion 35 to which the second plug is screwed, and the second receiving portion 34 connected to the third receiving portion.

In addition, an axial position of the guide shaft 43 may be adjusted within the sleeve 41 by the adjusting screw 46, so that the elasticity of the torsion spring 45 may be adjusted.

The spring hinge 40 configured in this manner may provide rotational force so that the second arm 30 rotates toward the first arm 20 in a folded direction.

In detail, when the second arm 30 is rotated in the direction of unfolding by applying external force by the user, the second connecting portion 33 rotates together with the second arm relative to the first connecting portion 23 of the first arm 20, and the catch fixing portion 44 of the spring hinge 40, the second receiving portion 34, the third receiving portion 35, and the guide shaft 43 rotate together.

At this time, since the sleeve 41 fixed to the first receiving portion 24 of the first connecting portion 23 and the spring seat 42 fixed to the sleeve do not rotate, the torsion spring 45 is wound, and thus torsional elastic force may be accumulated in the torsion spring.

When the external force by the user is released, a guide shaft 43 and a catch fixing portion 44 interlocked with each other through the first latch 47 and the second latch 48, and the second connecting portion 33 comprised of a second receiving portion 34 and a third receiving portion 35 fixed to the catch fixing portion, rotate in the reverse direction together with the second arm 30, by the restoring force of the torsion spring 45, thereby enabling the second arm to rotate in the direction of folding toward the first arm 20.

The configuration of the spring hinge 40 is not limited to the above-described and illustrated example, and any other arbitrary configuration may be adopted as long as the second arm 30 may be rotated in the direction of folding toward the first arm 20 when the external force is released. Furthermore, the present disclosure is not limited to the torsion spring 45, and a spring of another type may be adopted to provide restoring force to the second arm.

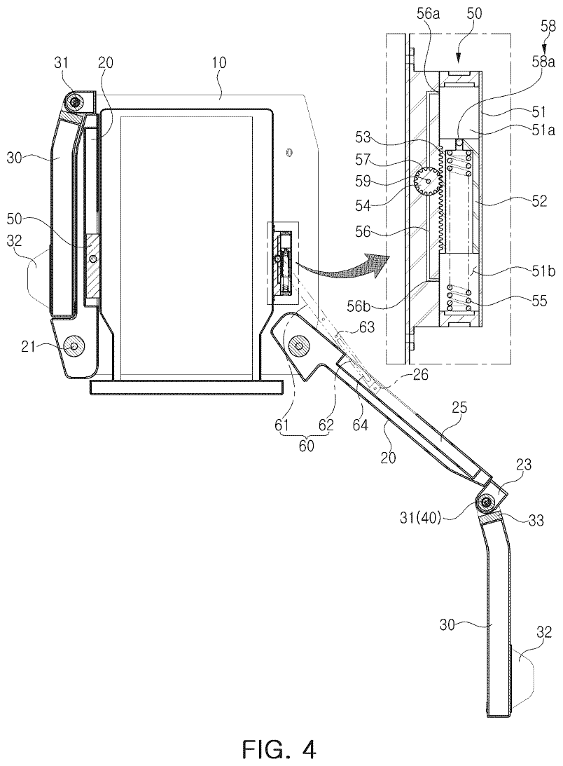

FIG. 4 is a cross-sectional view illustrating a pivot module of a charging apparatus according to an embodiment.

At least one pivot module 50 may be disposed on one side of the upper portion of the outer case 10, for example, but is not necessarily limited thereto. The drawings show an example in which a pair of pivot modules are disposed on both sides of the outer case, respectively.

In addition, the pivot module 50 is installed to be recessed from the surface of the outer case 10 and to be covered by the arms 20 and 30 when folded, thereby allowing the overall appearance of the charging apparatus to be kept simple and neat.

The pivot module 50 may include a cylinder 51, a piston 52, a rack 53 and a pinion 54, a coil spring 55, an operating fluid path 56, and a connecting rod 60.

The cylinder 51 may be mounted on one side of the outer case 10 and may have a hollow internal space. The internal space may accommodate operating fluid, and a pinion receiving portion 57 may be formed on the outside of the internal space. In addition, the operating fluid path 56 may be formed on one side wall of the cylinder.

The piston 52 is inserted into the internal space of the cylinder 51 and is capable of reciprocating while making sliding contact with the inner surface of the cylinder, and may be provided with a check valve 58 on one side thereof. A through hole through which the operating fluid may pass through and move is formed on the central axis of the piston. In the through hole, a ball member 58a that opens and closes the through hole so that the operating fluid flows only in a certain direction from the other side to one side of the piston may be disposed to form a check valve.

By this piston 52, the internal space of the cylinder 51 may be divided into a first chamber 51a adjacent to the check valve 58 and a second chamber 51b located on the opposite side of the first chamber based on the piston.

The rack 53 is formed on one side of the outer circumferential surface of the piston 52, and the pinion 54 disposed in the pinion receiving portion 57 is rotated by engaging with the rack to transmit driving force. The pinion is provided with a shaft 59 fixedly thereto so that the pinion and shaft may rotate together, and the shaft may be connected to the first arm 20 via a connecting rod 60.

The coil spring 55 may elastically support the piston 52 in the internal space of the cylinder 51. The coil spring may perform a function of returning the cylinder by the elastic force accumulated when the first arm 20 is unfolded so that the first arm may be folded toward the outer case 10.

The operating fluid path 56 may be formed on one side wall of the cylinder 51. The operating fluid path may communicate with the first chamber 51a and the second chamber 51b of the cylinder, and the pinion receiving portion 57. As a result, the operating fluid path allows the operating fluid to move between the first chamber and the second chamber.

To this end, the operating fluid path 56 may be provided with a first port 56a that communicates with the first chamber 51a and a second port 56b that communicates with the second chamber 51b.

As described above, the connecting rod 60 may connect the shaft 59 of the pinion 54 and the first arm 20. One end of the connecting rod may be fixedly coupled to the shaft and may rotate in a forward and reverse direction together with the shaft. The other end of the connecting rod may be rotatably connected to the middle of the first arm.

In the pivot module 50 configured in this manner, when the first arm 20 is unfolded, the rotational force applied to the pinion 54 by the connecting rod 60 and the shaft 59 linearly moves the piston 52 through the rack 53 that is engaged with the pinion, thereby compressing the coil spring 55 and accumulating elastic force in the coil spring.

When the external force by the user is released, the piston 52 is linearly moved in the reverse direction by the restoring force of the coil spring 55, and this movement of the piston may rotate the pinion 54 that is engaged with the rack 53 of the piston, thereby causing the shaft 59 and the connecting rod 60 to rotate together. Accordingly, the first arm 20 connected to the connecting rod may rotate in the direction of folding toward the outer case 10.

When the piston 52 reciprocates, the operating fluid filled in both sides of the piston, for example, the first chamber 51a and the second chamber 51b, may flow through the operating fluid path 56 of the cylinder 51 and/or the check valve 58 of the piston.

In detail, when the piston 52 presses the coil spring 55 when the first arm 20 is unfolded, the operating fluid in the second chamber 51b may flow toward the first chamber 51a through the second port 56b and the operating fluid path 56. At this time, the check valve 58 is opened.

When the piston 52 returns to the original position by the restoring force of the coil spring 55, the operating fluid in the first chamber 51a flows toward the second chamber 51b through the first port 56a and the operating fluid path 56, causing the first arm 20 to slowly fold toward the outer case 10. At this time, the check valve 58 is closed, and the folding speed of the first arm may be controlled by adjusting the flow rate of the operating fluid.

In some embodiments, the connecting rod 60 may include a first rod member 61 and a second rod member 62, and the length of the connecting rod may vary depending on the operation of the connecting rod.

One end of the first rod member 61 may be fixedly coupled to the shaft 59 and may rotate together with the shaft. At least one protrusion 63 protruding from the first rod member in the thickness direction may be formed on the other end of the first rod member.

One end of the second rod member 62 may be rotatably connected to the first arm 20. The second rod member may include a slot 64 extending along the longitudinal direction of the second rod member and penetrating in the thickness direction.

The protrusion 63 of the first rod member 61 is inserted into the slot 64 of the second rod member 62 and is movable within the slot, so that the length of the connecting rod 60 comprised of the first rod member 61 and the second rod member 62 may be varied according to the rotation of the connecting rod.

Meanwhile, in some embodiments, the first arm 20 may further include a rail 25 mounted on one side to extend along the longitudinal direction of the first arm, and a slider 26 installed on the rail and movable along the rail.

The rail 25 may be formed in a groove shape, but is not necessarily limited thereto, and for example, a separate rail may be mounted on one side of the first arm 20. The other end of the connecting rod 60 or one end of the second rod member 62 may be rotatably connected to the slider 26.

Accordingly, when the user applies a pulling force to the charging cable 11, the connecting rod 60 rotates, and the other end of the connecting rod may move toward the first hinge 21 along the rail 25 via the slider 26.

In the case where the connecting rod 60 includes the first rod member 61 and the second rod member 62, one end of the second rod member moves toward the first hinge 21 along the rail 25 via the slider 26, and at the same time, the length of the connecting rod increases, so that the first arm 20 may be smoothly unfolded.

When the pulling force is released, the connecting rod 60 rotates in reverse due to the elastic force accumulated in the coil spring 55 of the pivot module 50, and the other end of the connecting rod may move toward the second hinge 31 along the rail 25 via the slider 26.

In the case where the connecting rod 60 includes the first rod member 61 and the second rod member 62, one end of the second rod member moves toward the second hinge 31 along the rail 25 via the slider 26, and at the same time, the length of the connecting rod is reduced, so that the first arm 20 may be folded smoothly.

In addition, due to the action of the operating fluid in the pivot module 50, the return of the first arm 20 may be performed slowly and smoothly.

FIG. 5 is a plan view illustrating the state of use of a charging apparatus according to an embodiment.

First, when a user wanting to charge an electric vehicle 1 moves the charging gun 13 from the holder 14 of the outer case 10 toward the charging plug of the electric vehicle, the charging cable 11 is pulled from the outer case and moves toward the electric vehicle as the charging gun moves.

The second arm 30 connected to the charging cable 11 is unfolded from the first arm 20 by the user's pulling force, for example, external force, and then the first arm 20 may be unfolded from the outer case 10. Alternatively, the first arm may be unfolded first.

In the spring hinge 40 interposed between the first arm 20 and the second arm 30 and forming the second hinge 31, when the second arm is rotated in the direction of unfolding by external force from the user, the second connecting portion 33 rotates with the second arm relative to the first connecting portion 23 of the first arm, and the catch fixing portion 44, the second receiving portion 34, the third receiving portion 35, and the guide shaft 43 rotate together.

At this time, since the sleeve 41 fixed to the first receiving portion 24 of the first connecting portion 23 and the spring seat 42 fixed to the sleeve do not rotate, the torsion spring 45 is wound, and thus, torsional elastic force may be accumulated in the torsion spring.

In addition, in the pivot module 50, when the first arm 20 is unfolded, the rotational force applied to the pinion 54 by the connecting rod 60 and the shaft 59 causes the piston 52 to move linearly through the rack 53 that is engaged with the pinion, thereby compressing the coil spring 55 and accumulating elastic force in the coil spring.

In addition, the connecting rod 60 is rotated, and the other end of the connecting rod may move toward the first hinge 21 along the rail 25 via the slider 26. In the case where the connecting rod includes the first rod member 61 and the second rod member 62, one end of the second rod member moves toward the first hinge along the rail via the slider, and at the same time, the length of the connecting rod increases, so that the first arm 20 may be unfolded smoothly.

In this case, the first arm 20 may be rotated in a first direction (for example, clockwise) from the outer case 10 and unfolded, while the second arm 30 may be rotated in a second direction (for example, counterclockwise) from the first arm and unfolded. In detail, the unfolding directions of the first arm and the second arm may be opposite to each other.

Therefore, the charging gun 13 of the charging cable 11 may reach multiple vehicles having different positions of the charging plugs, and the charging gun may be connected to the corresponding charging plug.

Furthermore, since the charging cable 11 extends from the upper portion of the outer case 10 and simultaneously, is supported by the arms 20 and 30 on the upper portion of the outer case, the charging cable may be prevented from contacting the ground, which in turn prevents damage to the charging cable from the beginning.

When the connector of the charging gun 13 is connected to the charging plug of the electric vehicle 1 and the user's pulling stops, the charging cable 11 may be fixed by the coupling force between the connector of the charging gun and the charging plug.

Next, when the charging of the electric vehicle 1 is completed and the user detaches the charging gun 13 from the charging plug and moves the charging gun to the holder 14 of the outer case 10, the external force is released, for example, the user's pulling force is eliminated, so that the second arm 30 and the first arm 20 may be folded toward the outer case 10.

The arms 20 and 30 are automatically folded by the elastic force accumulated in the springs 55 and 45 provided in the pivot module 50 and the spring hinge 40, respectively.

In detail, in the spring hinge 40 constituting the second hinge 31, when the external force by the user is released, the guide shaft 43 and the catch fixing portion 44 interlocked with each other through the first latch 47 and the second latch 48, and the second connecting portion 33 comprised of the second receiving portion 34 and the third receiving portion 35 fixed to the catch fixing portion, are rotated in the reverse direction together with the second arm 30, by the restoring force of the torsion spring 45, and accordingly, the second arm may be rotated to be folded toward the first arm 20.

In addition, in the pivot module 50, when the external force by the user is released, the piston 52 is linearly moved in the reverse direction by the restoring force of the coil spring 55, and this movement of the piston may rotate the pinion 54 engaged with the rack 53 of the piston, so that the shaft 59 and the connecting rod 60 may also be rotated together. Accordingly, the first arm 20 connected to the connecting rod may be rotated in the direction of folding toward the outer case 10.

In addition, the connecting rod 60 is reversely rotated and the other end of the connecting rod may move along the rail 25 toward the second hinge 31 via the slider 26. In the case where the connecting rod has the first rod member 61 and the second rod member 62, one end of the second rod member moves along the rail toward the second hinge via the slider, and at the same time, the length of the connecting rod is reduced so that the first arm 20 may be folded smoothly.

In this case, due to the action of the operating fluid in the pivot module 50, the return of the first arm 20 may be performed slowly and smoothly. In addition, the folding directions of the first arm 20 and the second arm 30 may be opposite to each other.

When the arms 20 and 30 are folded, the arms are installed so that they are at least partially accommodated in the outer case 10, and thus, the overall appearance of the charging apparatus may be maintained simply and neatly.

As described above, according to an embodiment, by supporting the charging cable so that the charging cable does not come into contact with the ground due to the unfolding of the arms, contamination or damage to the charging cable may be prevented, and safety accidents may be prevented in advance.

In addition, according to an embodiment, since the charging cable is configured to be supported on an upper portion of the charging apparatus, the load of the charging cable felt by the user may be reduced, and since the charging cable may be connected to various vehicles having different positions of charging plugs, the convenience of the user may be increased.

Furthermore, according to an embodiment, the time and cost required for maintenance may be reduced by having a simple configuration, and since the arms are automatically returned to the original position after being operated only when the user pulls the charging cable, the visibility of the charging apparatus may be improved, and the appearance may also be improved.

While example embodiments have been illustrated and described above, it will be apparent to those skilled in the art that modifications and variations could be made without departing from the scope of the present disclosure as defined by the appended claims.

Therefore, the embodiments disclosed in this specification and drawings are not intended to limit the technical idea of the present disclosure but to explain it, and the scope of the technical idea of the present disclosure is not limited by these embodiments. The protection scope of the present disclosure should be interpreted by the claims below, and all technical ideas within the equivalent scope should be interpreted as being included in the scope of the rights of the present disclosure.

1. A charging apparatus comprising:
an outer case having a charging cable;
a first arm rotatably connected to the outer case;
a second arm rotatably connected to the first arm and supporting a portion of the charging cable; and
a pivot module mounted on the outer case and connected to the first arm via a connecting rod, the pivot module configured to allow the first arm to move toward the outer case when an external force is released.

2. The charging apparatus of claim 1, wherein the first arm is rotated and extended from the outer case in a first direction, and the second arm is rotated and extended from an end of the first arm in a second direction, and
the first direction and the second direction are opposite directions.

3. The charging apparatus of claim 1, wherein:
a first end of the first arm is connected to the outer case via a first hinge;
a first end of the second arm is connected to a second end of the first arm via a second hinge; and
the second hinge includes a spring hinge.

4. The charging apparatus of claim 3, wherein:
the second end of the first arm has a first connecting portion;
the first end of the second arm has a second connecting portion;
the first connecting portion includes a first receiving portion on an inside; and
the second connecting portion includes a second receiving portion and a third receiving portion spaced apart from each other;
wherein the second receiving portion is coupled to a first plug, and the third receiving portion is coupled to a second plug.

5. The charging apparatus of claim 4, wherein the spring hinge includes:
a sleeve inserted into the first receiving portion and fixedly coupled to the first receiving portion;
a spring seat fixedly coupled to an inner surface of the sleeve;
a guide shaft extending in a longitudinal direction of the sleeve within the sleeve, the guide shaft having a first end including a head formed with a plurality of first latches, and a second end inserted into the spring seat;
a catch fixing portion fixedly coupled to an inner surface of the second receiving portion, the catch fixing portion having a plurality of second latches configured to engage with the plurality of first latches;
a torsion spring surrounding the guide shaft within the sleeve, the torsion spring having a first end fixed to the spring seat and a second end fixed to the head; and
an adjusting screw configured to penetrate the second plug, and screw-connected to a second end of the guide shaft.

6. The charging apparatus of claim 5, wherein:
the sleeve, the spring seat, the first receiving portion, and the first connecting portion rotate together;
the guide shaft, the catch fixing portion, the second receiving portion, the third receiving portion, the second plug, and the second connecting portion rotate together; and
the spring hinge is configured to enable the second arm to rotate and to be folded toward the first arm by a restoration force of the torsion spring.

7. The charging apparatus of claim 1, wherein the pivot module includes:
a cylinder mounted in the outer case, having an internal space, and having operating fluid contained in the internal space;
a piston configured to be inserted into the internal space and capable of reciprocating, and dividing the internal space into a first chamber and a second chamber;
a rack formed on one side of an outer circumference surface of the piston;
a pinion disposed on an outside of the internal space, having a shaft, and engaged with the rack;
a coil spring configured to elastically support the piston in the internal space; and
an operating fluid path provided on one side wall of the cylinder and configured to communicate with the first chamber and the second chamber;
wherein the connecting rod connects the shaft and the first arm.

8. The charging apparatus of claim 7, wherein the piston includes a check valve, wherein the check valve includes a through hole formed in the piston and a ball member disposed in the through hole and configured to open and close the through hole.

9. The charging apparatus of claim 7, wherein:
a first end of the connecting rod is fixedly coupled to the shaft, and the connecting rod rotates together with the shaft;
a second end of the connecting rod is rotatably connected to the first arm; and
the pivot module is configured to rotate the first arm fold toward the outer case by a restoration force of the coil spring.

10. The charging apparatus of claim 7, wherein the connecting rod includes a first rod member and a second rod member, and a length of the connecting rod is variable.

11. The charging apparatus of claim 10, wherein:
a first end of the first rod member is fixedly coupled to the shaft, and a second end of the first rod member includes at least one protrusion;
a first end of the second rod member is rotatably connected to the first arm, and the second rod member includes a slot extending along a longitudinal direction of the second rod member; and
the protrusion is inserted into the slot and is movable within the slot.

12. The charging apparatus of claim 1, wherein the first arm includes a rail mounted on one side extending along a longitudinal direction of the first arm, and a slider installed on the rail and movable along the rail, and an end of the connecting rod is rotatably connected to the slider.

13. The charging apparatus of claim 12, wherein the rail has a groove shape.

14. The charging apparatus of claim 1, wherein the pivot module is recessed from a surface of the outer case and covered by the first arm and the second arm when the first arm and the second arm are folded.

15. The charging apparatus of claim 1, further comprising an outlet positioned on an upper portion of the outer case, wherein the charging cable is pulled out of the outlet, and wherein the first arm, the second arm, and the pivot module are disposed on an upper portion of the outer case.

16. The charging apparatus of claim 1, wherein the charging cable, the first arm, the second arm, and the pivot module are positioned on a first side of the outer case, and a second charging cable, a third arm, a fourth arm, and a second pivot module are positioned on a second side of the outer case.

17. The charging apparatus of claim 1, wherein the charging cable includes a charging gun positioned at one end.

18. A charging apparatus comprising:
an outer case having a charging cable;
a first arm rotatably connected to the outer case;
a second arm rotatably connected to the first arm and supporting a portion of the charging cable; and
a pivot module mounted on the outer case and connected to the first arm via a connecting rod, the pivot module configured to allow the first arm to move toward the outer case when an external force is released;
wherein the pivot module includes:
a cylinder mounted in the outer case, having an internal space;
a piston configured to be inserted into the internal space and capable of reciprocating;
a shaft positioned in the outer case and configured to be rotated by the piston; and
a coil spring configured to elastically support the piston in the internal space;
wherein a first end of the connecting rod is fixedly coupled to the shaft, and the connecting rod rotates together with the shaft;
wherein a second end of the connecting rod is rotatably connected to the first arm; and
wherein the pivot module is configured to rotate the first arm to fold toward the outer case by a restoration force of the coil spring.

19. The charging apparatus of claim 18, further comprising an outlet positioned on an upper portion of the outer case, wherein the charging cable is pulled out of the outlet, and wherein the first arm, the second arm, and the pivot module are disposed on an upper portion of the outer case.

20. The charging apparatus of claim 18, wherein:
a first end of the first arm is connected to the outer case via a first hinge;
a first end of the second arm is connected to a second end of the first arm via a second hinge; and
the second hinge includes a spring hinge.
